(19) United States
(12) Patent Application Publication
(10) Pub. No.: US 2018/0170594 A1
(43) Pub. Date: Jun. 21, 2018

(54) METHOD FOR MANUFACTURING PACKAGING

(71) Applicant: CHOCAL ALUMINIUMVERPACKUNGEN GMBH, Schwabisch Gmund (DE)

(72) Inventors: Thomas Speck, Goggingen (DE); Michael Sdahl, Schorndorf (DE); Joachim Scherr, Auenwald (DE); Konrad Bantleon, Gerstetten (DE)

(21) Appl. No.: 15/547,282

(22) PCT Filed: Jan. 29, 2016
(86) PCT No.: PCT/EP2016/051971

§ 371 Date: Oct. 10, 2017

(30) Foreign Application Priority Data
Jan. 30, 2015 (DE) 102015101417.3

(51) Int. Cl. B65B 25/00; B65D 85/60; B65D 53/06; B65B 11/50; B65B 51/32; B65D 75/32; A23G 1/50

(52) U.S. Cl. CPC B65B 25/005; B65D 85/60; B65D 53/06; A23V 2002/00; B65B 51/32; B65D 75/322; A23G 1/50; B65B 11/50

(57) ABSTRACT

The invention relates to a method for manufacturing packaging for a food product, in particular a hollow shaped chocolate article. In the disclosed method, two half-shells are provided, each of which includes a pre-shaped, curved thin foil having an edge that projects peripherally, a food product is introduced between the half-shells, the edges of the half-shells are coupled to one another such that the two half-shells accommodate the product in a cavity, a sealing layer being provided in at least some sections between the edges, and the edges are joined to one another using a sealing and folding process. In order to be able to carry out said method as easily and conveniently as possible, effectively seal the half-shells at the edges and obtain packaging that is esthetically appealing from the outside, the sealing process is performed at the same time as the edges are folded or after the edges have been folded. The disclosed manufacturing method results in packaging in which the sealed portion extends transversely across the fold line.

The invention refers to a method for manufacturing packaging for a food product, and to packaging for a food product, in particular a hollow shaped chocolate article, with the features of the preambles of the independent claims.

It is known about the packaging of hollow shaped chocolate articles that these are packed in a metal foil such that half-shells of a metal foil are pre-shaped for instance by shaping, such as deep-drawing or inserting and folding into a mold, whereby a peripherally projecting edge remains. A hollow shaped chocolate article is introduced between the two half-shells and the half-shells are subsequently placed with their edges one upon the other such that they accommodate the product and the contact areas of the edges form a coupling plane. Subsequently, the edges are interconnected by flanging or folding on their end sections, resulting in a circumferentially form-fittingly closed packaging. The product then has a so-called circumferential ring of Saturn which follows from the region of the mutually adjoining edges that has been flanged at least once. Normally, these mutually adjoining edges are folded once with their end regions by 180°.

It is suggested in DE 10 2011 002 754.8 that for obtaining packaging that is as tight as possible the pre-shaped metal foils should be provided over their whole surface with a sealing layer of thermoplastic material, for instance polypropylene or polyethylene. This way, the individual metal foils can be produced easily; as a rule, they can be produced from a metal foil material which is first flat over the whole surface, the material being provided with the coating and subsequently pre-shaped into the shape of the half-shells by slight deep-drawing. When the hollow shaped article is inserted between two half-shells and the edges thereof rest one on top of the other, the plastic layers are positioned between the edges resting one on top of the other and are interconnected, for instance by heating, on specific sections of the edges, resulting in a substance-to-substance bond which can subsequently be folded.

EP 2 765 081 A1 discloses a method of the above-mentioned type in which the half-shells are first formed by shaping, particularly deep-drawing, and by forming the laterally projecting edge. After a product has been inserted, a sealing operation is first carried out locally on the edge in such a manner that a small sealing seam which circumferentially surrounds the product is obtained on the region of the edge that is the outer one when viewed radially from the product. To this end a sealing bar which is heated is pressed from above onto the edges lying flat one on top of the other, but the edge is only sealed in a very small confined area when viewed in the cross section of the edge

After the sealing operation has been completed, the edge is cut such that the sealed region comes to rest on the very outside of the edge. The cutting operation is configured such that a folding operation is performed in a first step during cutting, in which folding operation the outer edge is deformed by about 90° relative to the otherwise horizontal coupling plane. In a subsequent second step this 90°-bent region is then folded back towards the product in parallel onto the remaining edge, resulting on the whole in a flanged edge in which the sealed region is arranged in the region of the edge that is distal when viewed from the product, whereas the folding line and the proximal region adjoining the curved cover is not sealed. It is here assumed that a connection with an esthetically improved look could be created with the sealing provided in the distal region of the edge. The flanged fold could then also closely snuggle against the product. Nevertheless, this method is relatively complicated and relies on the sealing provided in the distal end for achieving adequate tightness.

It is the object of the present invention to improve a method with accompanying packaging of the aforementioned type in such a manner that it can be carried out as easily and conveniently as possible, allows an efficient closing of the half-shells on the edges and produces packaging that is esthetically appealing and good looking to the outside.

This object is achieved according to the invention with a method having the features of the independent method claim.

The invention is based on the idea that the two edges can be well connected when the deforming process of the folding operation takes place together with the sealing or the sealing on an edge which is already pre-shaped by folding. When the folding and sealing operations are performed jointly, the seal connection can adapt particularly well to the fold connection also formed therewith, resulting in a desired strength of the connection and also an adequate tightness. It is advantageous when the sealing material can adapt to the deformation process or the pre-shaped fold during sealing. The resulting combined seal-fold connection is very reliable in practice and, as far as process efforts are concerned, it can be produced in just a few process sequences. Also from an esthetical point of view one achieves an excellent appearance of the packaging because the sealing operation also virtually takes into account the folding shape.

As a variant of the invention the edges can be pre-folded in a first step and finish-folded and sealed in a second step. The edges are pre-folded for instance by at least 90° or at other angular positions, so that a certain preform shape is ensured before the sealing operation then takes place in the second step together with the finish-folding operation. It is also possible that a distal region of the edges is already folded back around a folding line in the first step completely onto the proximal region of the edges which is provided near the cavity, and so to speak a finish-folding operation then takes place in the second step during sealing and heat application, e.g. by additional exertion of pressure, so that the fold is consolidated in its technical form and sealing is performed.

It is conceivable that the edges can be sealed together in the region transversely across a folding line. This combines the connection of the folding operation with the sealing operation, i.e. force locking and form locking, i.e. both in the area of the folding line. This leads to a particularly effective and tight connection which in addition can be well formed. Although both types of connection are thereby concentrated at one location, the resulting folding line is nevertheless esthetically appealing and sufficiently tight.

Advantageously, the edges can be sealed together in the region of the edge that is proximal to the cavity. This connection allows a good sealing as close as possible to the curvature of the half-shells, so that the two mold halves are held together as close as possible at the food product.

At least one sealing punch of a sealing tool can possibly be pressed from at least one side onto the edges. The sealing tool serves here to apply heat and also to exert pressure on possibly pre-folded edges, so that these are there sealed and further deformed. This can be carried out relatively rapidly and efficiently on the one hand and leads, on the other hand, to a very compact, small, finish-connected circumferential edge region.

According to a further design the edges can be pressed together from two sides between sealing punches and can be sealed. The temperatures applied by the sealing punches can thus be kept low because the heat input from two sides continues at a faster pace up to the sealing material. This is particularly advantageous in hollow shaped chocolate articles in which the chocolate of the finished article should not be affected by the packaging, if possible.

As a further development of the invention the sealing punches can be movable from both sides and can be pressed onto the edges. The actuation of pressure to the edges can thereby be controlled in a more targeted way. Owing to the movability of the sealing punches at both sides the two sealing punches can mutually compensate each other to some degree with respect to the compression force upon pressing. This promotes a gentle treatment of the edges of thin foil, and an edge region which is more homogeneous and more uniformly sealed on the whole is obtained. It has been found with specific types that it might be possible to exert less pressure.

According to a special embodiment a cooling element may be ahead of the sealing punch in the movement direction to the edge. This ensures that the cooling element gets into contact with the edge before the sealing punch, so that the edge and the food product to be packed are protected against excessive sealing energy, particularly in the form of heat.

Especially, the cooling element can be in contact with the edge at least for such a long time that the sealing energy has been delivered to the edge. This ensures an adequate cooling of the food product as long as energy is introduced. Optionally, the cooling punch can also remain in contact with the edge for such a long time that the sealing process is fully completed, i.e. the desired connection is established by sealing.

According to a possible idea of the invention a cooling element may follow the sealing punch from a sealing position, in movement direction away from the edge. Hence, the movement of the sealing punch out of the sealing position, i.e. in a direction away from the edge, is ahead of the release movement of the cooling element. This ensures a reliable cooling of the product with respect to the sealing punch adjoining the edge and an early moving away of the sealing punch while cooling is still maintained at least in part.

As a variant of the invention, sealing can be performed with contact heat and/or ultrasound. This allows a good sealing of the standard sealing materials, such as polypropylene or polyethylene, or thin plastic layers in general. As a rule, a heat transfer by way of contact to the edge and to the sealing material is enough. With the help of ultrasound the method can be carried out in a very targeted and precise manner, and enough heat is produced so that the seal for a tight closing of the two mold halves on the edges is completely formed.

The sealing punch can possibly only press against a part of the edge to be folded and/or exert its sealing action at that place, and preferably only a radially outer region of the edge to be folded can be sealed. Although folding is here also performed with the sealing punch, it is enough for a good sealing that only a part of the edge to be folded is pressed down by the sealing punch. Nevertheless, a good sealing evolves in this area and the edge is sufficiently folded.

It is conceivable that the cooling punch acts on the one hand as a cooling element to lower the heat input into the food product. On the other hand, folding is also performed with the cooling punch, so that it also has a deforming effect with respect to the edge. This allows a good folding or flanging of the edge, especially when the cooling punch is provided very close to and optionally in a manner almost adjoining the food product.

It is conceivable that the cooling punch can be arranged between the sealing punch and the food product. This ensures a good protection of the food product against excessive heat input.

The object according to the invention is further achieved by packaging which is particularly produced according to any one of the aforementioned method claims, the packaging comprising the features of the independent apparatus claim.

This combines the connections of the folding operation with the sealing operation, i.e. force locking and form locking, namely both in the area of the folding line. This leads to a particularly efficient and tight connection which in addition can be established in an easy way. Although both types of connection are thereby concentrated at one location, the evolving folding line is nevertheless esthetically appealing and sufficiently tight.

It is conceivable that the sealed region can extend into the distal region and/or into the proximal region. This allows a sealing region, starting from the folding line, which extends into the distal and/or into the proximal region and thus combines a combination of the folded region with the region in which the two foils of the half-shells are still adjoining each other approximately in plane-parallel fashion. The combination of these seals can be achieved easily and allows a particularly good sealing.

Specific embodiments of the invention will now be explained with reference to the drawing, in which:

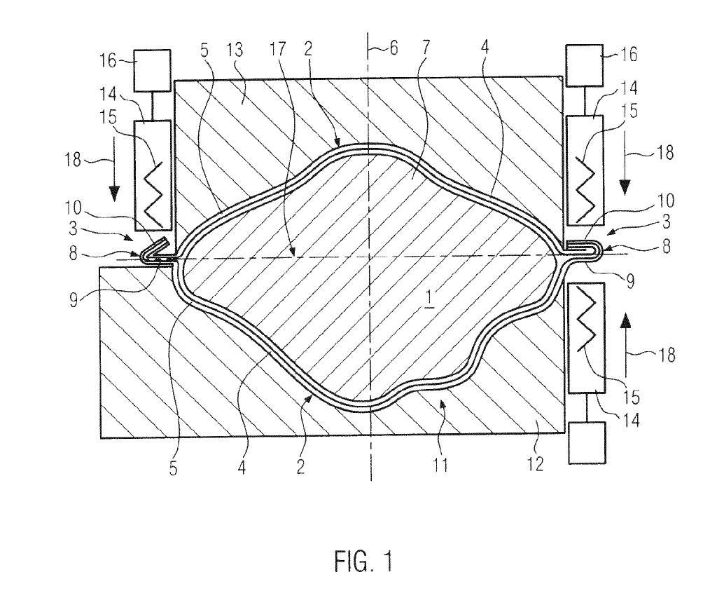

FIG. 1 is a schematic view of a method step according to the invention according to a first embodiment during use in an apparatus, with two variants;

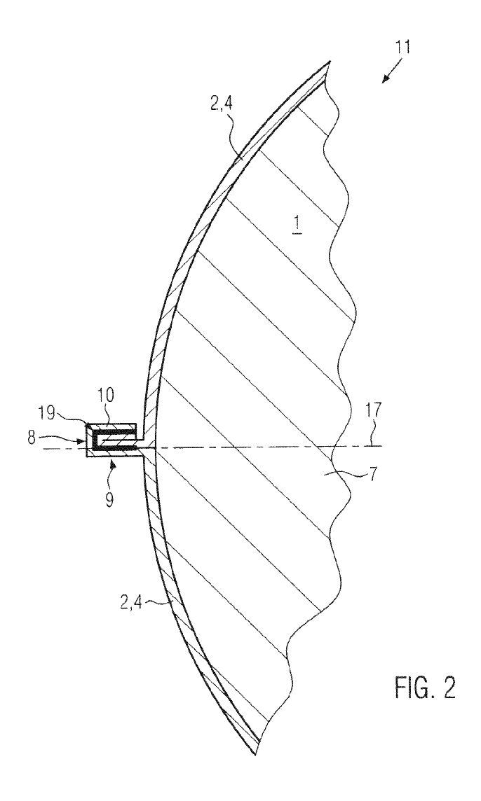

FIG. 2 is an enlarged sectional view of a packaging according to the invention with a sealing according to a first variant,

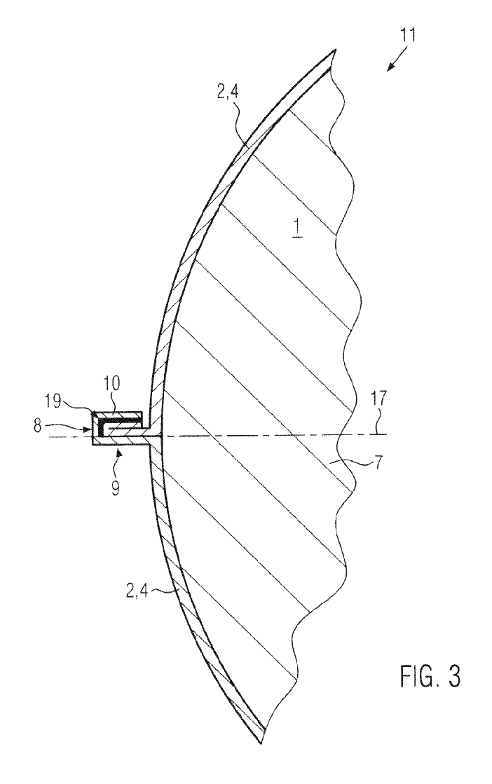

FIG. 3 is an enlarged sectional view of a packaging according to the invention with a sealing according to a second variant,

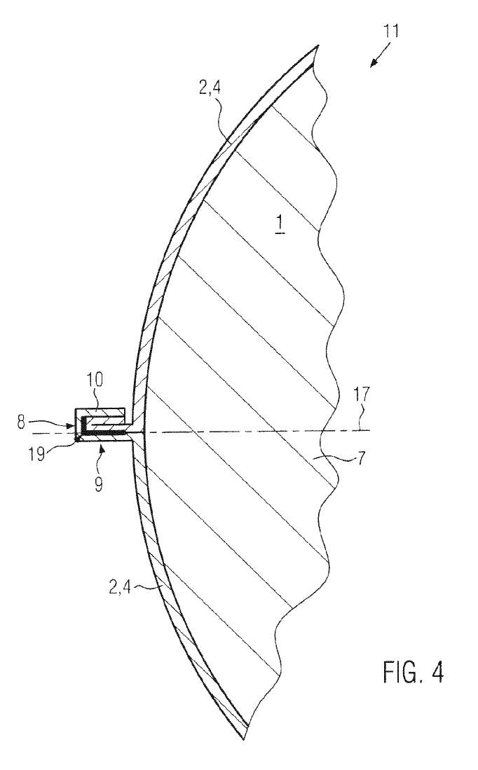

FIG. 4 is an enlarged sectional view of a packaging according to the invention with a sealing according to a third variant,

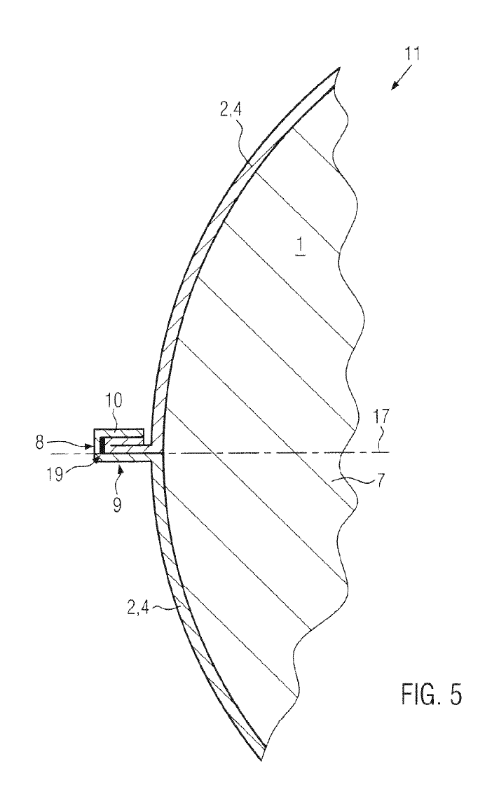

FIG. 5 is an enlarged sectional view of a packaging according to the invention with a sealing according to a fourth variant,

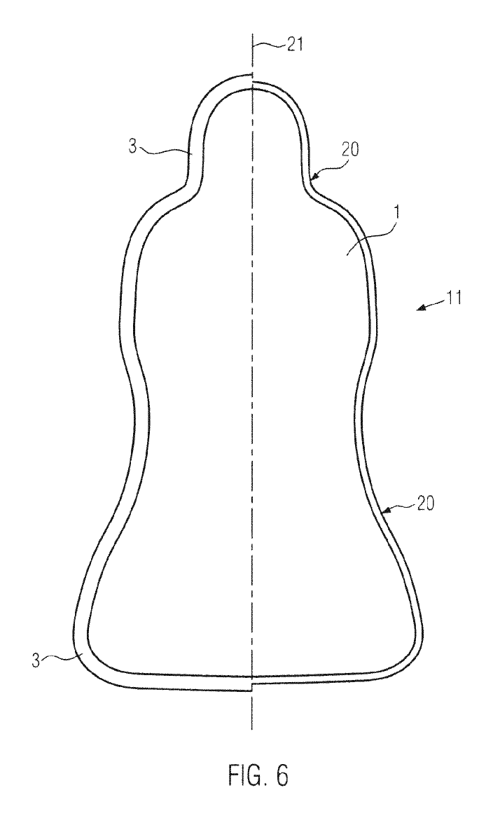

FIG. 6 is a top view on a packaging according to the invention, and

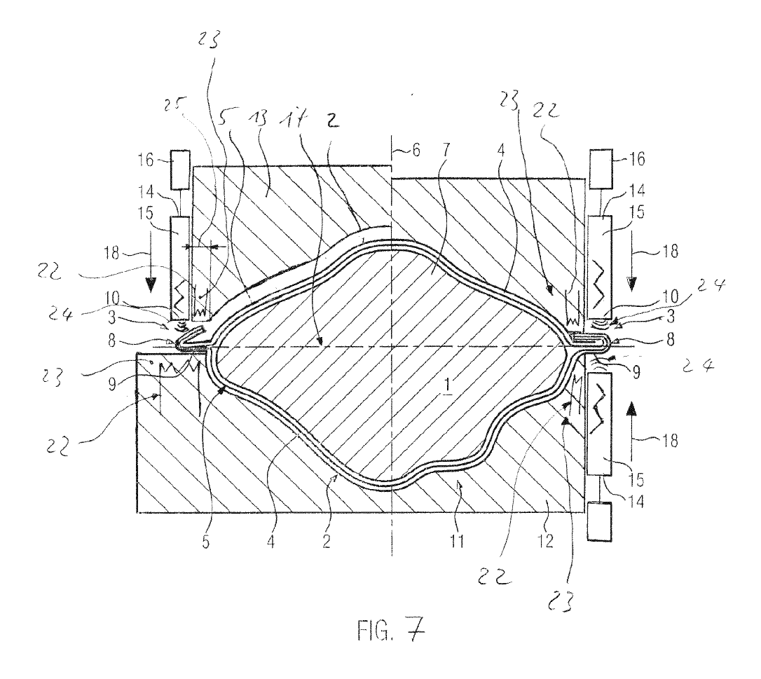

FIG. 7 is a schematic view of a method step according to the invention according to a second embodiment during use in an apparatus, with two variants.

FIG. 1 shows a food product 1, such as for instance a hollow shaped chocolate article. Hollow shaped chocolate articles or figures are known in different shapes, for instance as an egg, Santa Claus or Easter Bunny. Such hollow shaped confectionery articles have a relatively thin shell because of their inner cavity and thus a rather fragile stability. On the other hand, they have special shape designs to conform to specific figures. Such shapes may have somewhat complicated designs that are difficult to package. In general, however, it is possible with the present invention to package also food products, such as confectionery bars, for instance chocolate bars or muesli bars, cheese or other foodstuff, which internally have no separate cavity, but consist of solid material.

Product 1 is provided between two half-shells 2 which in their contour snuggle against the outer form of the product 1 and consist each of a pre-shaped, curved thin foil with a peripherally projecting edge. Preferably, metal foil, particularly aluminum foil, with a thickness of 5 to 100 μm, particularly 10 to 50 μm, and particularly advantageously 15 to 40 μm, is used as the foil.

On the side facing the product 1, the foils 4 are provided with a sealing layer 5, for instance of polypropylene or polyethylene, over their entire surface. In reality, the sealing layer 5 is made much thinner than the thickness of the foil and is shown in the drawing for reasons of representation with an almost similar thickness. It can also be configured in the sense of an adhesive bonding.

On the edges 3 the two half-shells 2 adjoin each other with their sealing layers 5 facing each other.

Merely for purposes of illustration, FIG. 1 shows a left and a right half which are separated from each other by a vertical center line to illustrate different variants of the invention.

Both variants resemble each other insofar as they show the product 1 which is introduced into and accommodated in a cavity 7 formed from the pre-shaped half-shells 2 by connecting the mutually adjoining edges to each other.

In the left half of FIG. 1, the edges of the two half-shells are already rudimentarily folded together, whereby a folding line 8 is formed which subdivides the edge in the illustrated cross-sectional representation into a region 9 proximal to the cavity 7 and into a distal region 10 further away from the cavity. The folding line with these pre-folded regions extends circumferentially around the whole packaging 11 and the food product 1, respectively, but could also be interrupted in specific embodiments at the circumference.

The aluminum foil was pre-shaped by shaping, particularly deep-drawing or folding, into the half-shells 2 and provided with the sealing layer 5. One of the half-shells 2 was laid into a lower tool shell 12 which has is shaped corresponding to the half-shell 2. The product 1 was inserted thereinto, and the other half-shell 2 was subsequently placed from above on the product 1 and an upper tool shell 13 was arranged for holding the half-shells 2 and the product 1 accommodated thereinbetween.

The pre-folding of the edges 3, as shown in the left view, was carried out in a preceding product step (not shown here). The edges 3 are here only pre-folded such that the proximal and the distal regions 9, 10 are still spaced apart from each other, but extend at a relatively small, preferably acute angle towards each other.

In the left half of FIG. 1, the proximal region rests on the lower tool shell 12 and is supported by it in a flat manner. At the opposite upper side a sealing punch 14 is provided, which is heated. For heating purposes a kind of coiled filament is here illustrated by way of example as a heating device 15. The sealing punch 14 is provided with a movement mechanism 16 outlined in the manner of a block, with which it can be moved approximately vertically, i.e. in a direction perpendicular to a coupling plane 17 extending approximately radially from the product 1. An arrow 18 outlines the direction of the movement of the sealing punch 14 towards the pre-folded edges 3. When the sealing punch 14 is moved downwards, the distal region 10 of the edges is then pressed down in parallel with the proximal region 9 of the edges and heat is introduced by exerting pressure, with the heat heating the sealing layer 5 and causing the substance-to-substance sealing of the half-shells 2 to each other. In this arrangement the sealing punch 14 presses against a firm support for the edges 3. After a specific holding time the sealing punch 14 can then be returned again in a direction opposite to the arrow 18.

In the right half of FIG. 1, two sealing punches 14 are provided in this variant, a respective one at each side of the edges 3. As outlined with arrows 18, they can be moved with the help of separate movement mechanisms 16 towards the edges 3, so that they are clamped thereinbetween and heat is introduced into the edges 3 by heating devices 15 of the sealing punches. As a consequence, the opposing sealing layers form a substance-to-substance bond. The folded region is here also more strongly pressed together by the pressure of the sealing punches, so that deformation takes place.

In the right half of FIG. 1 the edges 3 were pre-folded such that the distal and proximal regions 9, 10 of the edges 3 are directly adjoining each other and are approximately in parallel with each other. The folding line 8 is thereby more perfectly curved. During the sealing operation with the help of the sealing punch 14 a further compressing operation and the sealing operation then take place, as has been explained above.

FIG. 2 schematically shows an enlarged cross-sectional view on a finish-sealed edge which has for instance been produced in the manner shown in the right half of FIG. 1. For reasons of clarity only part of the sealing layer 5 is shown, in which sealing takes place. The sealing 19 is there recognizable by way of a region shown in a slightly thickened form. This region is positioned between the edges 3 in the proximal region 9, in the distal region 10 and in the region of the folding line 8. The folding line is shown here, ideally with a blunt outer edge. In reality, the half-shells 2 are so thin that an acute outer corner is formed, which seems to be a circumferential folding line on the outer side.

In contrast to the variant of FIG. 2, FIG. 3 shows a possible packaging in which the heat input for sealing takes place only from one side, here onto the folded-in distal region, so that sealing is performed in this distal region 10 and the folding line 8, wherein the proximal region may be sealed less or not at all. This is for instance achievable with an apparatus and procedure as shown in the left half of FIG. 1.

As a further modification of FIGS. 2 and 3, FIG. 4 shows packaging in which heat was also introduced at one side, so that a sealing 19 took place in the proximal region 9 and the folding line 8.

Hence, sealing can optionally take place only in the proximal or the distal region, with the folding line 8 being respectively co-sealed.

In specific cases the sealing can extend, starting from the folding line, only about 2 mm beyond the distal and/or proximal region 9, 10, so that adequate distance is ensured from the cavity with the hollow shaped chocolate article. Here, a distance of also about 2 mm can for example be observed.

As an additional modification of FIGS. 2 to 4, FIG. 5 shows a configuration in which sealing 19 takes place only in the area of the folding line 8. Moreover, the illustrations of FIG. 5 conform to the illustrations of like parts as shown in FIGS. 2 to 4 and described in this respect.

A sealing which should take place only in the region of the folding line, can be achieved by the targeted application of heat, e.g. when a sealing punch 16 with heating device 15 is configured such that adequate heat for sealing is virtually only delivered in the folding line 8 without any full sealing of the distal or the proximal region.

In a way which is not shown here, the edges can subsequently be placed in a further possible method step also on the outer contour of the half-shells 2.

FIG. 6 shows a top view on a packaging 11 of a product 1, which view shows in the left-side area a folded edge according to one of FIGS. 2 to 5, which edge projects approximately radially from the half-shells 2 while in the right-side area said edge is closely placed on the outer three-dimensional shape of the half-shells 2, resulting in a placed edge 20 which projects much less from the half-shell 2. The center line 21 in FIG. 5 is located in the same plane as the center line 6 in FIG. 1. In the same way, FIG. 1 represents a horizontal section through the packaging 11 with the product 1 of FIG. 5 although there is no one-to-one correspondence of the dimensions.

Hence, in these embodiments of the invention the sealing process can be performed together with the folding operation, or the sealing operation can also take place only after the folding operation. The edges may optionally be pre-folded in a first step, as shown in FIG. 1, and then finish-folded and sealed in a second step by use of the sealing punch. In the subsequent sealing process the folding proportion may also be less, depending on how strong the pre-folding operation was already in the first step.

It is here particularly advantageous for the connection of the edges when a co-sealing operation takes place in the area of the folding line virtually transversely across the folding line. The sealing regions can here optionally extend into the distal and/or into the proximal region, depending on the degree of the heat input from which side.

If two sides press against the edges, this may lead to a gentler stress on the edges or their connection with the rest of the half-shells 2.

When the heat input takes place from two sides, as shown for instance in FIG. 1 in the right half, the temperatures applied may be lower than for instance in the left figure in FIG. 1 when the total heat input takes place from one side with a sealing punch. Low temperatures are more advantageous to avoid interference with the product 1, especially a melting of chocolate. For instance, when a sealing punch is used, there may be temperatures approximately in the range of 130° to 160°, particularly 140° to 150°, whereas in the case of two punches it is also possible to work in the range of 90° to 110°, in particular about 100°. In these temperature ranges a good melting or sealing with the help of the sealing material also takes place.

This yields packages which are adequately tight and can be produced easily. Although they are sealed in the area of the folding line, they can nevertheless be designed in an appropriately esthetic manner.

FIG. 7 shows a second embodiment which is modified with respect to the embodiment of FIG. 1. Reference is made to the description regarding the first embodiment according to FIG. 1 if nothing different is explained in the following. Like parts have like reference numerals in FIGS. 1 and 7.

In the area above the coupling plane 17 the upper tool shell 2 is shown in two different positions. In the area at the left side from the center line 6 it is shown in a position spaced upwardly from the food product 1 and the half-shell 2. In the area at the right side from the center line 6 it is shown in a position in abutment with the half-shell 2; it also presses here against the edge 3 to be folded.

The upper tool shell 13 is in this case configured as a cooling element. Cooling can take place over the whole tool shell, but is in particular performed in the lateral regions with which the upper tool shell is pressed against the edge 3. This is symbolized by cooling coils 22 in this region. In principle, however, such a cooling can also take place in a different way.

By analogy the lower tool shell 12 can also be configured as a cooling element. Corresponding cooling coils 22 are there shown in the area impinging on the edge 3.

In the area at the left side from the center line 6 the upper tool shell 13 is lifted approximately at the same distance upwardly from the edge and the half-shell 2, respectively, as the sealing punch 14. In the area at the right side from the center line 6 the upper tool shell 13 which is formed as the cooling element is moved downwards onto the food product and the half-shell, respectively, so that it is in contact with the half-shell 2 and the edge, respectively, and is pressed with a section against the edge. Each section is configured as a cooling punch 23. In the illustration at the right side from the center line 6 the sealing punch is still in the initial position spaced apart from the edge, in a similar way as in the left half of the figure, whereas the upper tool shell has already been moved down with the cooling punch 24 to press against the edge. Thus, the upper tool shell and the cooling punch, respectively, are ahead of the sealing punch 14 when the tool is closed. The sealing punch 14 gets into contact with the edge only after the cooling punch 23.

In the left half of the figure the edge 3 is shown in an already slightly inwardly bent condition, but still projects at an angle from the part of the edge positioned in the coupling plane 17.

When the upper tool shell 13 is moved downwards, as shown in the right half of the figure, the edge 3 is pressed downwards by the cooling punch 23, so that, apart from the deformation, it is also cooled at the same time. Subsequently, the sealing punch 14 is moved downwards and remains in contact with the edge until enough sealing heat is introduced into the edge and the sealing layer 5. The same movement is analogously carried out by the heating device 15 which in the right half of the figure presses against it from below, so that they press approximately at the same time from above and from below against the edge and keep the edge in the desired shape.

In addition or as an alternative to the mere contact heat, which is shown by way of the heating device 15 shown as a heating coil, heat input can also take place through ultrasound 24 by providing for instance ultrasonic transmitters in the heating devices 15. The ultrasound 24 to be emitted by an ultrasonic transmitter is illustrated by way of three sonic wave lines in FIG. 7. Thus the sealing layer can also be heated in an adequate way, so that an adequate good sealing operation takes place in the area of the edge.

Depending on the method chosen, the cooling punch 23 can then remain in contact with the edge, with the heating devices 15 being first removed from the edge. This ensures that the food product is always adequately protected.

In this method the cooling punch 23 serves cooling and folding, and the sealing punch 14 serves the energy input and folding operation.

In the left half of the figure a width 25 is outlined by way of dimension lines for the section of the cooling punch 23 which cuts on the edge. For an edge of a chocolate bar product which protrudes in the customary way and which is to be packed into a metal foil, preferably aluminum, said width B is about 1-3 mm, preferably 1.5-2.5 mm and particularly about 2 mm.

As for the edge 3 or the coupling plane 17, respectively, seen from the interior of the food product outwardly, the cooling punch 23 is provided between the food product and the sealing punch.

Optionally, the cooling punch 23 may also be provided separately with respect to the tool shell 12, 13 and optionally also be moved up and down independently thereof. Thus, the cooling punch 23 can for instance be provided in a separately movable way in the area of the region pressing with its width 25 from the edge. This can be implemented on the upper as well as in the lower tool shell. Thus, the function of the tool shells can be increasingly directed to the holding of the half-shells on the food product, whereas the cooling punch 23 and the cooling element, respectively, can be geared in their movement and configuration in an improved manner to the mere function of cooling and folding on the corresponding lateral sections for a proper folding and sealing of the edge.

In this invention the cooling element may be configured in the manner of a cooling bell in quite a general manner, with the cooling bell extending in the manner of a bell over the product.

Furthermore, the sealing punch can be connected for operation together with a sealing hoist.

1-16. (canceled)

17. A method for manufacturing packaging (11) for a food product (1), wherein two half-shells (2) are provided, each of which includes a pre-shaped, curved thin foil (4) having an edge (3) that projects peripherally, a food product (1) is introduced between the half-shells, and the edges (3) of the half-shells (2) are coupled to one another such that the half-shells accommodate the food product (1) in a cavity (7), wherein a sealing layer (5) is provided in at least some sections between the edges (3), and the edges (3) are joined to one another by sealing and folding, wherein the sealing is performed at the same time as the edges (3) are folded.

18. The method according to claim 17, wherein the food product (1) is a hollow shaped chocolate article.

19. The method according to claim 17, wherein the edges (3) are sealed to one another in a region transversely across a folding line (8).

20. The method according to claim 17, wherein the edges (3) are sealed to one another in a region (9) of the edge (3) that is proximal to the cavity (7).

21. The method according to claim 17, wherein the edges (3) are pressed together from two sides between sealing punches (14) and are sealed.

22. The method according to claim 21, wherein the sealing punches (14) are movable from both sides and are pressed onto the edges (3).

23. The method according to claim 21, wherein a cooling element (13, 23) is ahead of the sealing punch (14) in the movement direction towards the edge (3), wherein the cooling element (13, 23) is in contact with the edge (3) at least until the sealing energy has been delivered to the edge (3).

24. The method according to claim 21, wherein a cooling element (13, 23) follows the sealing punch (14) from a sealing position, in movement direction away from the edge.

25. The method according to claim 22, wherein the sealing punch (14) only presses against a part of the edge (3) and/or exerts its sealing action such that only a radially outer region of the edge to be folded is sealed.

26. The method according to claim 17, wherein folding is performed with the help of a cooling punch (23).

27. The method according to claim 21, wherein a cooling punch (23) is arranged between the sealing punch (14) and the food product (1).

28. A method for manufacturing packaging (11) for a food product (1), wherein two half-shells (2) are provided, each of which includes a pre-shaped, curved thin foil (4) having an edge (3) that projects peripherally, a food product (1) is introduced between the half-shells, and the edges (3) of the half-shells (2) are coupled to one another such that the half-shells accommodate the product (1) in a cavity (7), wherein a sealing layer (5) is provided in at least some sections between the edges, and the edges (3) are joined to one another using a sealing and folding process, wherein the sealing process is performed after the edges (3) have been folded.

29. The method according to claim 28, wherein the food product (1) is a hollow shaped chocolate article.

30. The method according to claim 28, wherein the edges (3) are pre-folded in a first step and are finish-folded and sealed in a second step.

31. The method according to claim 28, wherein the edges (3) are sealed to one another in a region transversely across a folding line (8).

32. The method according to claim 28, wherein at least one sealing punch (14) of a sealing tool is pressed from at least one side onto the edges (3).

33. The method according to claim 32, wherein the edges (3) are pressed together from two sides between sealing punches (14) and are sealed.

34. The method according to claim 32, wherein a cooling element (13, 23) is ahead of the sealing punch (14) in the movement direction towards the edge (3).

35. The method according to claim 34, wherein the cooling element (13, 23) is in contact with the edge (3) at least for such a long time that the sealing energy has been delivered to the edge (3).

36. The method according to claim 32, wherein a cooling element (13, 23) follows the sealing punch (14) from a sealing position, in movement direction away from the edge.

37. The method according to claim 28, wherein folding is carried out with the help of a cooling punch (23).

38. Packaging (11) for a food product (1), with two half-shells (2), each of which includes a pre-shaped, curved thin foil (4) having a peripheral edge (3), wherein the half-shells (2) are coupled to one another on the peripheral edges (3) along a coupling plane (17) and form a cavity (7) accommodating the food product (1), and the peripheral edges (3) are joined to one another using a sealing and folding process, wherein folded edges (3) have a region (9) proximal to the cavity (7) and a region (10) distal to the cavity (7), a folding line (8) being provided between said regions, wherein a sealed region (19) extends transversely across the folding line (6).

39. Packaging (11) according to claim 38, wherein the food product (1) is a hollow shaped chocolate article.
